(19) United States
(12) Patent Application Publication
(10) Pub. No.: US 2010/0275930 A1
(43) Pub. Date: Nov. 4, 2010

(54) Two-color mouth guard and the method of making the same

(76) Inventor: Jeffrey M. Evans, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/387,393

(22) Filed: May 1, 2009

(51) Int. Cl. A63B 71/08; B29C 39/12

(52) U.S. Cl. 128/861; 264/245

(57) ABSTRACT

A plastic athletic mouth guard with one wing section thereof having a first color and the other wing section thereof having a second color. The mouth guard is formed by a 2-shot injection molding process.

### BACKGROUND OF THE INVENTION

1. Field of the Invention

This invention relates to an athletic mouth guard and more particularly relates to an athletic mouth guard comprised of two different colored mouth guard halves. More particularly, the invention relates to a two-colored mouth guard which is formed by a 2-shot injection molding process.

2. Description of the Related Art

Many types of athletic mouth guards which are comprised of a flexible plastic material have been previously provided. Many of the prior art mouth guards have been colored with some of the mouth guards having been provided with two different colors so that the wearer may display the wearer's school colors. In the past, it is believed that the two-colored mouth guards were formed with the use of two different molds to separately form the two halves of the mouth guard with those two separate halves then being glued or otherwise secured together to form the mouth guard.

Applicant has found that if the mouth guard is formed by a 2-shot injection molding process, the resultant mouth guard does not require the gluing or attachment process and that the separation of the two colors in the finished product is more distinct than otherwise possible.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A two-colored athletic mouth guard is provided as well as the method of producing the same. In the method, to produce a flexible U-shaped mouth guard having first and second wing sections, an injection mold is provided having a cavity corresponding to the desired mouth guard. The mold is placed in a 2-shot injection molding machine and two different colored plastic materials are injected into the mold by a 2-shot injection molding process to form a single piece mouth guard with a first wing section thereof having a first color and the second wing section thereof having a second color.

The mouth guard of this invention is formed by a 2-shot molding machine so that one-half of the mouth guard has a first color and so that the other half of the mouthpiece has a second color. In one embodiment, the mouth guard fits over the wearer's upper teeth. In another embodiment, the mouth guard fits over the wearer's lower teeth. In the preferred embodiment, the mouth guard of this invention fits over the wearer's upper and lower teeth.

It is therefore a principal object of the invention to provide a two-colored mouth guard which is formed by a 2-shot injection molding process.

A further object of the invention is to provide a mouth guard of the type described which comprises two distinct and different colors.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the mouth guard of this invention with the hatching thereof illustrating that the mouth guard is comprised of two different colors;

FIG. 2 is a top view of the mouth guard of FIG. 1;

FIG. 3 is a perspective view of a 2-shot injection molding cavity in communication with the 2-shot injection molding machine.

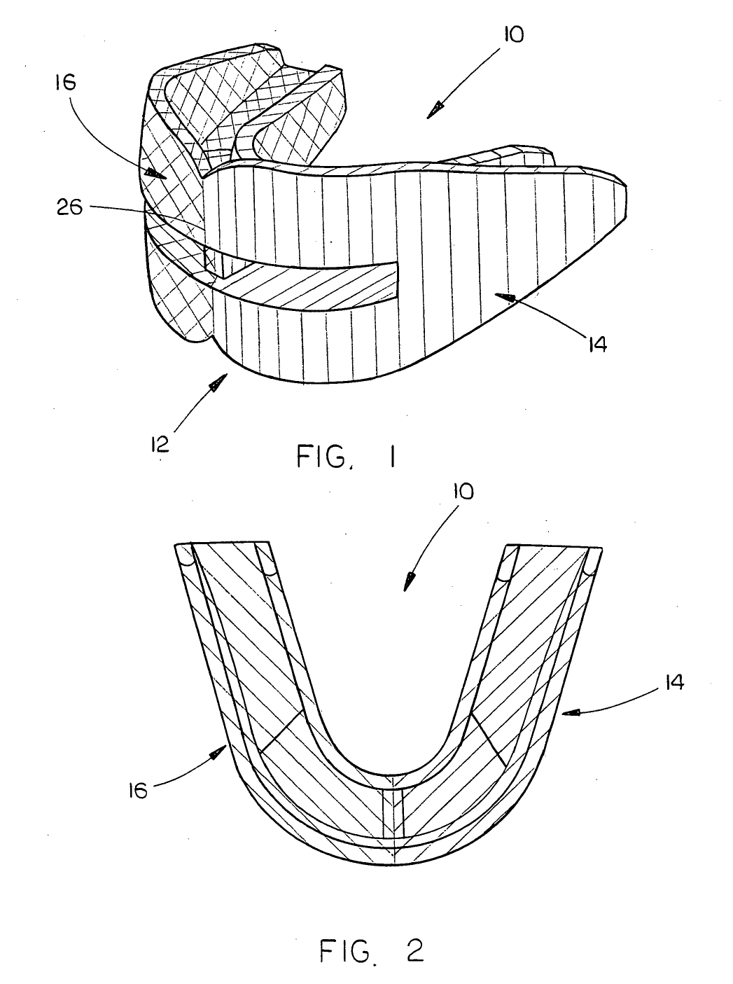

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to the flexible plastic athletic mouth guard of this invention which includes a main body 12 having a first wing section 14 and a second wing section 16. Wing section 14 has a color different than the second wing section 16 as indicated by the hatching in FIG. 1. For example, if the wearer is participating in a sport for the University of Nebraska, wing section 14 would have a white color with wing section 16 having a red color, inasmuch as the school colors of the University of Nebraska are red and white.

The mouth guard 10 of this invention is designed to fit over the wearer's upper and lower teeth. In some cases, the mouth guard 10 will only be designed to only fit over the wearer's lower teeth and in some cases it will be designed so as to fit only over the wearer's upper teeth. The mouth guard 10 is comprised of conventional plastic materials commonly used in the production of athletic mouth guards.

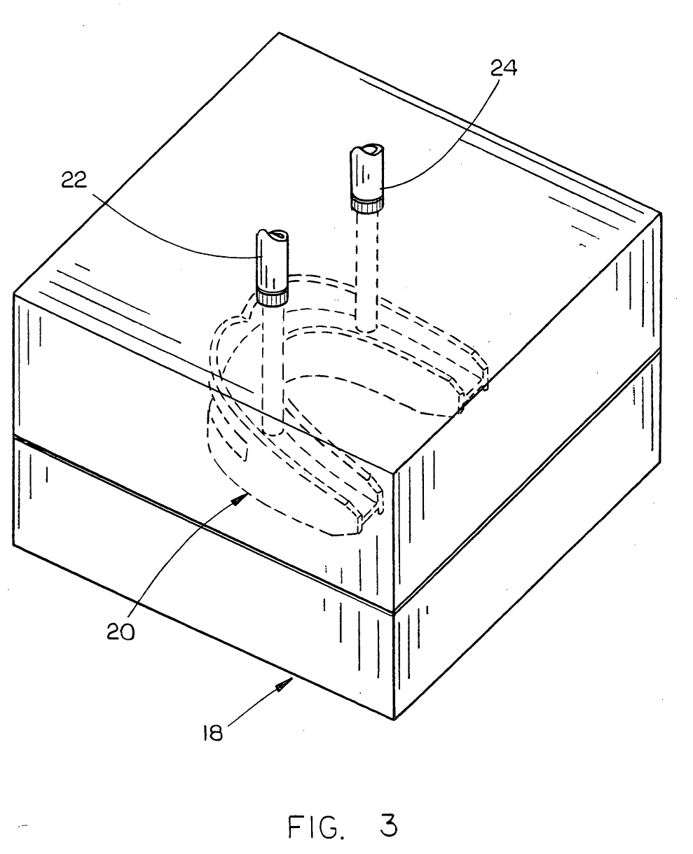

In FIG. 3, the numeral 18 refers to a mold used with a 2-shot injection molding machine with the mold 18 having a cavity 20 formed therein which has the shape of the desired mouth guard. A pair of shot tubes 22 and 24 extend from the 2-shot injection molding machine and are designed to simultaneously inject two plastic materials having different colors into the cavity 20 in the mold 18 so that the resultant mouth guard 10 is achieved. The use of the 2-shot molding machine insures that the juncture line of the two colors in the mouth guard 10 will be very distinct and definite. The use of the 2-shot injection molding process eliminates the need of separately forming the wing sections of the mouth guard and then securing or attaching the same together to form the mouth guard.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. The method of molding a plastic mouth guard including a flexible U-shaped main body having first and second wing sections, comprising the steps of:
providing an injection mold having a cavity corresponding to the desired mouth guard;
providing a 2-shot injection molding machine;
2-shot injecting two plastic materials into the mold to form a single piece mouth guard with said first wing section having a first color and said second wing section having a second color.

2. A flexible plastic mouth guard formed by a 2-shot injection molding machine so that one-half of the mouth guard has a first color and so that the other half of the mouthpiece has a second color.

3. The flexible plastic mouth guard of claim 2 wherein said mouth guard fits over the wearer's upper teeth.

4. The flexible plastic mouth guard of claim 2 wherein said mouth guard fits over the wearer's lower teeth.

5. The flexible plastic mouth guard of claim 3 wherein said mouth guard also fits over the wearer's lower teeth.
